(19) United States
(12) Patent Application Publication
(10) Pub. No.: US 2012/0017167 A1
(43) Pub. Date: Jan. 19, 2012

(54) ELECTRONIC BOOK READING DEVICE AND METHOD FOR CONTROLLING THE SAME

(76) Inventors: Chia-Ying LEE, Taipei City (TW); Chi-Han Wang, Taipei City (TW)

(21) Appl. No.: 13/180,980

(22) Filed: Jul. 12, 2011

(30) Foreign Application Priority Data
Jul. 13, 2010 (TW) 099123041

(51) Int. Cl. G06F 3/048

(52) U.S. Cl. 715/776

(57) ABSTRACT

A method for controlling an electronic book reading device is provided. The electronic book reading device includes a touch screen. The method includes the following steps. A page of the electronic book reading device is displayed on the touch screen in one of a full-screen mode and a non-full-screen mode. A central area is defined on the touch screen. When a click event corresponding to the central area is triggered, the page of the electronic book reading device is displayed on the touch screen in the other mode.

### CROSS REFERENCE TO RELATED APPLICATIONS

This Non-provisional application claims priority under 35 U.S.C. §119(a) on Patent Application No(s). 099123041 filed in Taiwan, Republic of China on Jul. 13, 2010, the entire contents of which are hereby incorporated by reference.

### BACKGROUND OF THE INVENTION

1. Field of Invention

This disclosure relates to an electronic book reading device and, more particularly, to an electronic book reading device and a method for controlling the same.

2. Related Art

Conventionally, a touch screen can provide a user interface of an electronic book reading device, and a capacitive touch screen is a common type. Users can directly touch the touch screen to control various functions of the electronic book reading device via cooperation of the touch screen and software of controlling the electronic book reading device.

However, the conventional electronic book reading device fails to provide an intuitional user interface.

### SUMMARY OF THE INVENTION

The invention relates to an electronic book reading device and a method for controlling the same. The electronic book reading device includes a touch screen.

According to one embodiment of the invention, a method for controlling an electronic book reading device is provided. The electronic book reading device includes a touch screen. The method for controlling the electronic book reading device includes the following steps. A page of the electronic book reading device is displayed on the touch screen in one of a full-screen mode and a non-full-screen mode. A central area is defined on the touch screen. When a click event corresponding to the central area is triggered, the page of the electronic book reading device is displayed in the other mode.

According to another embodiment of the invention, an electronic book reading device is provided. The electronic book reading device includes a touch screen displaying a page of the electronic book reading device in one of a full-screen mode and a non-full-screen mode. A central area is defined on the touch screen. When a click event corresponding to the central area is triggered, the touch screen displays the page of the electronic book reading device in the other mode.

In embodiments of the invention, the touch screen of the electronic book reading device may include a plurality of areas. When click events corresponding to different areas are triggered, respectively, operation instructions for controlling the electronic book reading device can be correspondingly triggered. Accordingly, compared with the conventional electronic book reading device, the electronic book reading device according to the invention can provide a more intuitional user interface.

These and other features, aspects, and advantages of the present invention will become better understood with regard to the following description, appended claims, and accompanying drawings.

### BRIEF DESCRIPTION OF THE DRAWINGS

FIG. 1 is a block diagram showing an electronic book reading device according to one embodiment of the invention;

FIG. 2 is a schematic diagram showing a frame displayed on a touch screen in FIG. 1;

FIG. 3 is a schematic diagram showing another frame displayed on the touch screen in FIG. 1; and

FIG. 4 is a flow chart showing a method for controlling an electronic book reading device according to one embodiment of the invention.

### DETAILED DESCRIPTION OF THE INVENTION

In an electronic book reading device according to one embodiment of the invention, operation instructions are generated for controlling the electronic book reading device via click events corresponding to different areas of a touch screen.

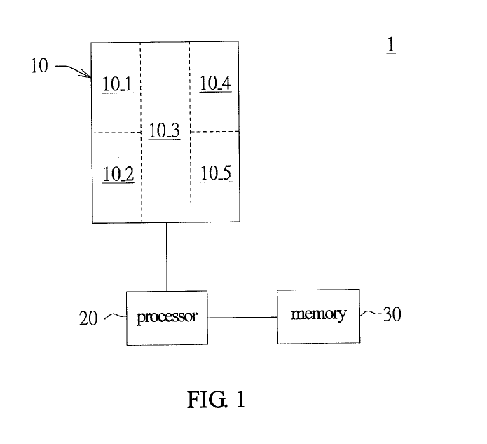

FIG. 1 is a block diagram showing an electronic book reading device according to one embodiment of the invention. In FIG. 1, the electronic book reading device 1 includes a touch screen 10, a processor 20, and a memory 30. The memory 30 stores various instruction set for driving the electronic book reading device 1 to execute various operations, and the processor 20 access the instruction set in the memory 30 thus to control the electronic book reading device 1.

The processor 20 accesses the instruction set in the memory 30 and defines the touch screen 10 into a plurality of areas such as five areas 10_1, 10_2, 10_3, 10_4, and 10_5 in FIG. 1. A click event corresponding to the areas 10_1 to 10_5 is correspondingly triggered in response to a click action of a user. For example, the click action of the user may be a single click to the areas 10_1 to 10_5, respectively. The processor 20 correspondingly executes an operation instruction according to the click event corresponding to the different areas thus to control the electronic book reading device 1 in executing the corresponding operation.

In the embodiment, the processor 20 defines the area 10_3 as a central area. When the user clicks the central area 10_3, a click event corresponding to the central area 10_3 is triggered. In response to the click event corresponding to the central area 10_3, the processor 20 executes an instruction for switching a display mode, allowing the touch screen 10 to be switched to a full-screen mode or a non-full-screen mode.

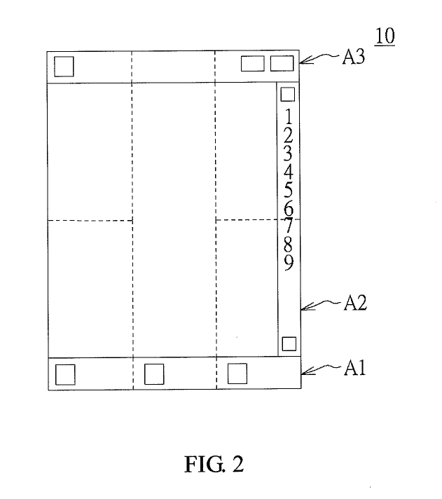

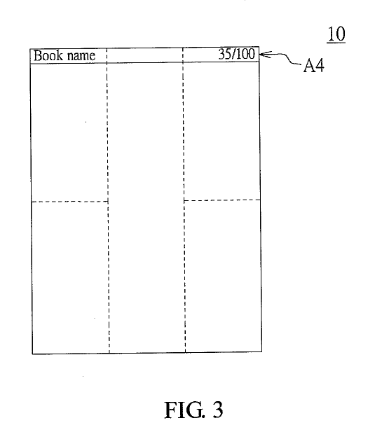

FIG. 2 is a schematic diagram showing a frame displayed on a touch screen in FIG. 1. FIG. 3 is a schematic diagram showing another frame displayed on the touch screen in FIG. 1. Please refer to FIG. 2 and FIG. 3. At first, the electronic book reading device 1 operates in the non-full-screen mode, and the touch screen 10 may display a page of the electronic book reading device as shown in FIG. 2. Parts of display areas on the touch screen 10 display an upper control bar A3, a right control bar A2, and a lower control bar A1, thus allowing the touch screen 10 to display an instant operation area such as a title of the electronic book reading device currently being read, a page number currently being turned to, operation options, and an index and data of the electronic book reading device. When the click event corresponding to the central area is triggered, as shown in FIG. 3, the touch screen 10 is correspondingly switched from the non-full-screen mode to the full-screen mode. The touch screen 10 only displays a reduced control bar A4, or it does not display any control bar, thus allowing the data of the electronic book reading device to be concisely displayed.

According to another embodiment of the invention, at first, as shown in FIG. 3, the electronic book reading device 1 operates in the full-screen mode. When the click event corresponding to the central area is triggered, as shown in FIG. 2, the touch screen 10 is correspondingly switched from the full-screen mode to the non-full-screen mode.

Accordingly, the user can just touch the central area to trigger the click event, thus driving the electronic book reading device 1 to switch the display mode of the touch screen 10.

In the embodiment of the invention, the processor 20 defines the areas 10_1 and 10_2 as a left area and defines the areas 10_4 and 10_5 as a right area. In operation, the user can touch the left area thus to trigger the click event corresponding to the left area. In response to the click event corresponding to the left area, the processor 20 executes a PageUp instruction, thus driving the touch screen 10 to display a previous page.

In operation, the user can touch the right area thus to trigger the click event corresponding to the right area. In response to the click event corresponding to the right area, the processor 20 executes a PageDn instruction, thus driving the touch screen 10 to display a next page.

In another embodiment of the invention, in response to the click event corresponding to the left area, the processor 20 executes a PageDn instruction, thus driving the touch screen 10 to display a next page; in response to the click event corresponding to the right area, the processor 20 executes a PageUp instruction, thus driving the touch screen 10 to display a previous page.

Accordingly, the user can just trigger the click event in the left area or the right area, thus driving the touch screen 10 to display the previous or the next page.

In the embodiment of the invention, although the areas 10_1 and 10_2 are defined as the left area and the areas 10_4 and 10_5 are defined as the right area, the electronic book reading device 1 is not limited thereto. For example, one of the areas 10_1 and 10_2 can be defined as the left area, while the other one is not defined. On the other hand, one of the areas 10_4 and 10_5 can be defined as the right area, while the other one is not defined.

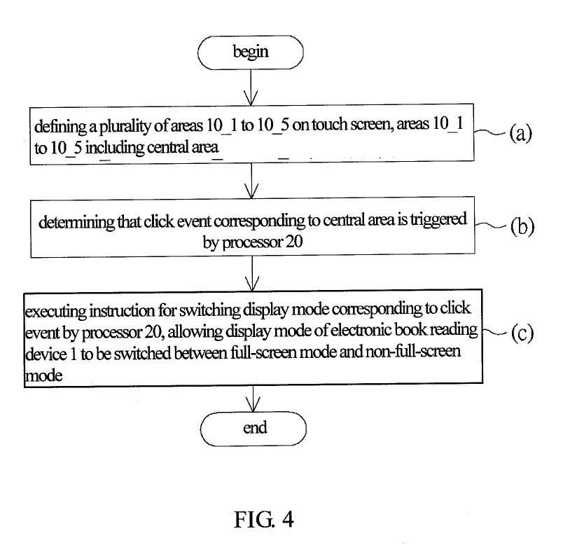

FIG. 4 is a flow chart showing a method for controlling an electronic book reading device according to one embodiment of the invention. Please refer to FIG. 4. In step (a), a plurality of areas 10_1 to 10_5 are defined on the touch screen 10, and the areas 10_1 to 10_5 include a central area. A click event corresponding to the areas 10_1 to 10_5 is correspondingly triggered in response to a click action of a user, and the processor 20 correspondingly executes operation instructions in response to the click events corresponding to the areas 10_1 to 10_5.

In step (b), the processor 20 determines that the click event corresponding to the central area is triggered. In step (c), the processor 20 executes an instruction for switching a display mode corresponding to the click event, allowing the display mode of the electronic book reading device 1 to be switched between the full-screen mode and the non-full-screen mode.

The electronic book reading device according to the embodiment of the invention includes the touch screen which includes a plurality of areas. The user can touch different areas to trigger corresponding click events, thus allowing corresponding operation instructions to be executed to control the electronic book reading device. Accordingly, the electronic book reading device according to the embodiment of the invention can provide a more intuitional user interface.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for controlling an electronic book reading device, the electronic book reading device including a touch screen, the method comprising the following steps of:
displaying a page of the electronic book reading device on the touch screen in one of a full-screen mode and a non-full-screen mode;
defining a central area on the touch screen; and
displaying the page of the electronic book reading device on the touch screen in the other mode when a click event corresponding to the central area is triggered.

2. The method for controlling an electronic book reading device according to claim 1, further comprising the step of:
defining a left area and a right area on the touch screen, the left area being on the left of the central area, the right area being on the right of the central area.

3. The method for controlling an electronic book reading device according to claim 2, further comprising the steps of:
executing a PageUp instruction when a click event corresponding to the left area is triggered; and
executing a PageDn instruction when a click event corresponding to the right area is triggered.

4. The method for controlling an electronic book reading device according to claim 2, further comprising the steps of:
executing a PageDn instruction when a click event corresponding to the left area is triggered; and
executing a PageUp instruction when a click event corresponding to the right area is triggered.

5. An electronic book reading device, comprising:
a touch screen, displaying a page of the electronic book reading device in one of a full-screen mode and a non-full-screen mode, a central area being defined on the touch screen,
when a click event corresponding to the central area is triggered, the touch screen displaying the page of the electronic book reading device in the other mode.

6. The electronic book reading device according to claim 5, wherein the touch screen comprises a left area on the left of the central area and a right area on the right of the central area.

7. The electronic book reading device according to claim 6, wherein when a click event corresponding to the left area is triggered, the touch screen displays a previous page of the electronic book reading device, and when a click event corresponding to the right area is triggered, the touch screen displays a next page of the electronic book reading device.

8. The electronic book reading device according to claim 6, wherein when a click event corresponding to the left area is triggered, the touch screen displays a next page of the electronic book reading device, and when a click event corresponding to the right area is triggered, the touch screen displays a previous page of the electronic book reading device.
